(19) United States
(12) Patent Application Publication
(10) Pub. No.: US 2022/0382916 A1
(43) Pub. Date: Dec. 1, 2022

(54) Vendor Independent Facilities for Applications to Access a Secure Memory Device

(71) Applicant: Micron Technology, Inc., Boise, ID (US)

(72) Inventors: Olivier Duval, Pacifica, CA (US); Shivamurthy Shastri, Munich (DE)

(21) Appl. No.: 17/727,623

(22) Filed: Apr. 22, 2022

Related U.S. Application Data
(60) Provisional application No. 63/194,417, filed on May 28, 2021.

(51) Int. Cl. G06F 21/78; G06F 21/60; H04L 9/08; H04L 9/32

(52) U.S. Cl. CPC G06F 21/78; G06F 21/602; H04L 9/0825; H04L 9/3242

(57) ABSTRACT

A system, apparatus and method to provide vendor independent access to secure memory devices via an abstraction layer, which can be implemented via an operating system kernel and one or more utility programs. After receiving a request to perform a function, the abstraction layer uses parameters provided in the request to generate at least one first command in a format independent of a specification of the memory device. The at least one first command is provided to a device driver of the memory device identified in the request, causing the memory device to generate at least one second command to the memory device according to the specification of the memory device. The second command includes a signature generated using a portion of the second command; and the function is implemented by execution of the at least one second command in the memory device.

### RELATED APPLICATIONS

The present application claims priority to Prov. U.S. Pat. App. Ser. No. 63/194,417 filed May 28, 2021, the entire disclosures of which application are hereby incorporated herein by reference.

### TECHNICAL FIELD

At least some embodiments disclosed herein relate to accessing secure memory devices in general and more particularly, but not limited to, techniques to allow applications to access secure memory devices in a way independent of implementations or specifications of secure memory devices from different manufacturers.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a system having an abstraction layer for secure memory devices to allow applications to access secure memory devices in a way independent from hardware implementations of secure memory devices.

FIG. 2 illustrates command and response structures for accessing secure memory devices of one embodiment.

FIG. 3 illustrates an integrated circuit memory device having a security manager according to one embodiment.

FIG. 4 illustrates a technique to control execution of a command in a memory device according to one embodiment.

FIG. 5 shows a method of accessing a secure memory device according to one embodiment.

FIG. 6 illustrates an example computing system having a memory sub-system in accordance with some embodiments of the present disclosure.

FIG. 7 is a block diagram of an example computer system in which embodiments of the present disclosure can operate.

### DETAILED DESCRIPTION

At least some aspects of the present disclosure are directed to an abstraction layer for secure memory devices.

A secure memory device uses cryptography to control access to functions of the secure memory device. For example, a privileged command received in the secure memory device is to be signed using a correct cryptographic key before the command can be executed within the secure memory device; and the cryptographic key is representative of the privilege of having the command executed in the secure memory device. Different vendors/manufacturers can offer similar security features with different implementations of access control in their secure memory devices. For example, commands to support access control based on cryptography can have different syntax, formats, and/or specifications for secure memory devices from different manufacturers.

An abstraction layer provides a standardized model of secure memory devices that have a predefined application programming interface (API) for applications to access security features in a standardized way. For example, a set of utility programs can offer a set of common commands for typical usages of the security features offered by different vendors/manufacturers. The utility programs can receive parameters from applications and implement their functions by calling the operating system kernel and invoking commands defined for the standardized model of secure memory device. The operating system kernel can route the commands to corresponding devices drivers of secure memory devices from respective vendors/manufacturers. The device drivers can implement the received commands, defined based on the standardized model of secure memory devices, using commands specific to the secure memory devices offered by the respective vendors/manufacturers and operated by the respective device drivers. Thus, an application programmed to use the utility programs to access secure memory devices can work with different secure memory devices offered by different vendors or manufacturers of secure memory devices.

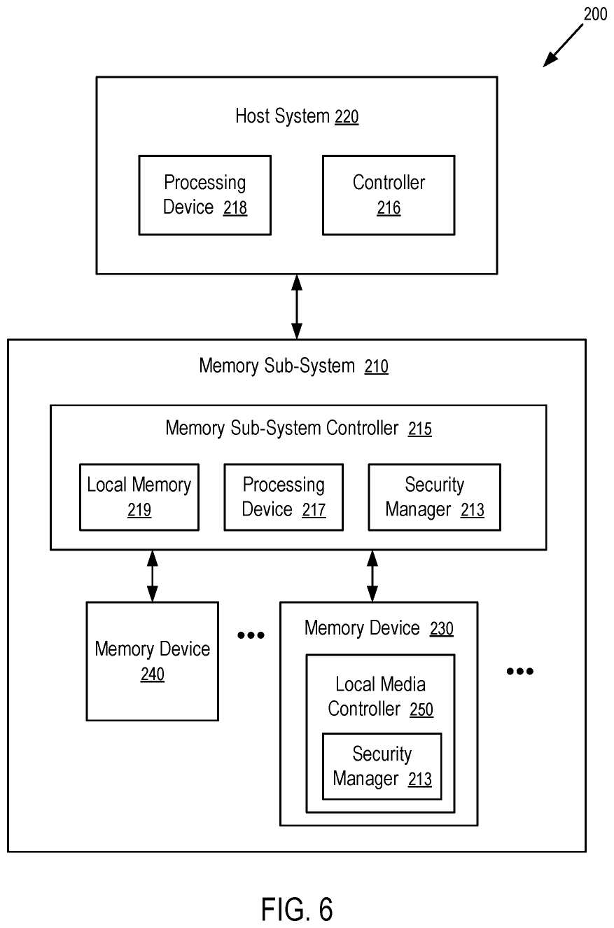

Secure memory devices can be configured in a memory sub-system. Examples of storage devices and memory modules as memory sub-systems are described below in conjunction with FIG. 6. In general, a host system can utilize a memory sub-system that includes one or more components, such as memory devices that store data. The host system can provide data to be stored at the memory sub-system and can request data to be retrieved from the memory sub-system.

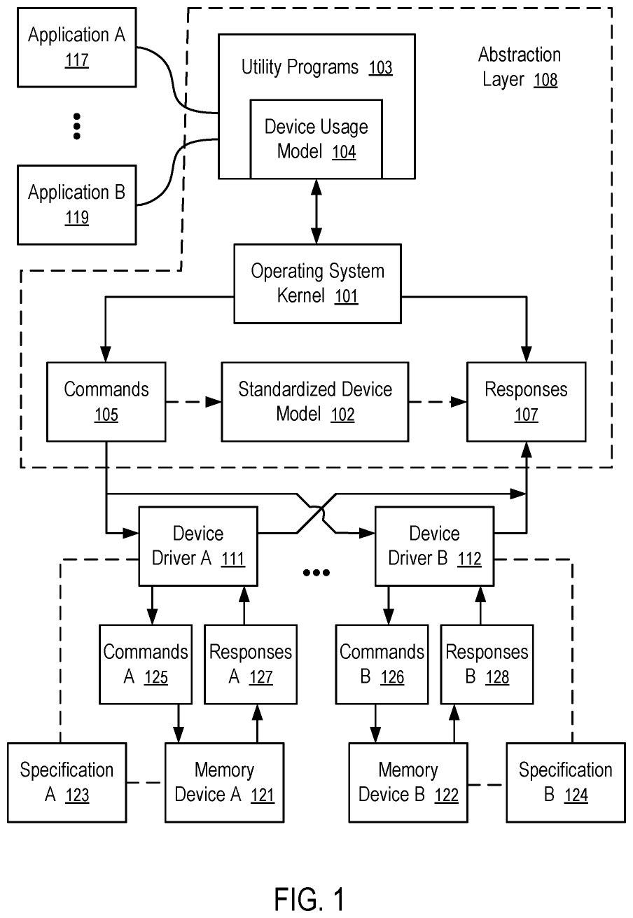

FIG. 1 shows a system having an abstraction layer 108 for secure memory devices (e.g., 121, 122) to allow applications to access the secure memory devices (e.g., 121, 122) in a way independent from hardware implementations of the secure memory devices (e.g., 121, 122).

In FIG. 1, the abstraction layer 108 is implemented using utility programs 103 and an operating system kernel 101.

The operating system kernel 101 is implemented according to a standardized device model 102 of secure memory devices (e.g., 121 and 122). Commands 105 processed by the standardized device model 102 provide responses 107. For example, the commands 105 include signatures to be checked for access control based on cryptography before the standardized device model 102 provides the responses 107 that provide the results requested by the commands 105; and if the signatures are invalid, the responses 107 indicate errors.

The commands 105 and the responses 107 of the standardized device model 102 can be implemented using a combination of a device driver (e.g., 111 or 112) and a corresponding secure memory device (e.g., 121 or 122) supported and/or operated by the device driver (e.g., 111 or 112).

For example, a memory device 121 can be manufactured according to a specification 123 such that commands 125 received in the memory device 121 provides responses 127. The manufacturer specification 123 identifies configurations of timing, format, syntax, and/or other aspects of commands to and responses from the memory device 121. The device driver 111 implements the commands 105 issued to the standardized device model 102 using the commands 125 to the memory device 121, and generates the responses 107 to the commands 105 using the responses 127 from the memory device 121.

Similarly, another memory device 122 can be manufactured according to a different specification 124 such that commands 126 received in the memory device 122 provides responses 128. The device driver 112 implements the commands 105 issued to the standardized device model 102 using the commands 126 to the memory device 121, and generates the responses 107 to the commands 105 using the responses 128 from the memory device 122.

To implement the same commands 105, the device drivers 111 and 112 can generate different commands 125 and 126 according to the different device specifications 123 and 124 for the respective secure memory devices 121 and 122. The corresponding responses 127 and 128 to the respective commands 125 and 126 are in general different (e.g., in syntax, format and/or sequence). The device drivers 111 and 112 can generate the same responses 107 for the commands 105 based on the different responses 127 and 128. Thus, the memory device 121 operated by the device driver 111 and the memory device 122 operated by the device driver 112 can implement the same standardized device model 102 in generating the response 107 for the commands 105.

In FIG. 1, utility programs 103 offer a predefined set of application programming interface (API) for accessing security features according to a device usage model 104. A utility program 103 can be used by an application (e.g., 117 or 119) to perform a security function on the standardized device model 102. The utility program 103 can check the parameters received from the application (e.g., 117 or 119), allocate resources for implementing the function, format parameters to generate the data for the operating system kernel 101 to issue the commands 105 to a relevant device driver (e.g., 111 or 112), and call the operating system kernel 101 with the generate data to cause the operating system kernel to issue the commands 105. A sequence of commands 105 can be used to implement the function of a utility program 103 to provide a friendly response, while shielding the details of the standardized device model 102 from the applications 117, . . . , 119. Thus, the usage of the security features of the standardized device model 102 can be greatly simplified for the applications 117, 119.

In some implementations, the utility programs 103 and/or the device drivers (e.g., 111, 112) are configured to have access to cryptographic keys to sign the commands (e.g., 125, 126) to be transmitted to the respective memory devices (e.g., 121, 122). Alternatively, the applications (e.g., 117, 119) are configured to communicate the signatures to the utility programs 103 to allow the generation of the commands (105, 125, 126) that include the signatures. For example, the utility programs 103 and/or the device drivers (e.g., 111, 112) can generate the message to be signed and request the applications (e.g., 117, 119) to provide the signatures for the messages formatted by the utility programs 103 and/or the device drivers (e.g., 111, 112).

For example, a utility program 103 can be implemented as a command-line command. An application (e.g., 117 or 119) can request the operating system to run the utility program 103, passing data required for the utility program 103 as command-line arguments. Some of the arguments can specify a file that contains data to be used by the utility program 103. The utility program 103 can call the operating system kernel 101 to issue the commands 105, and provide responses in the standard output channel (or in a file) based on the responses 107.

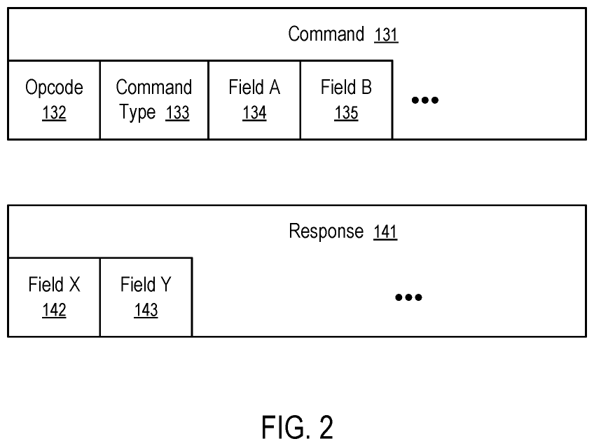

FIG. 2 illustrates command and response structures for accessing secure memory devices according to one embodiment.

For example, the command and response structures of FIG. 2 can be used for the commands 105 and responses 107 of the standardized device model 102, for the commands 125 and responses 127 of a memory device 121 from one vendor according to a device specification 123, and/or for the commands 126 and responses 128 of another memory device 122 from another vendor according to another device specification 124. The standardized device model 102 and the specifications 123 and 124 can use similar overall structures of commands and responses as in FIG. 2, but different definitions of syntax, fields, operating sequences, sizes, and/or value interpretations, etc.

In FIG. 2, a typical command 131 has a number of bytes to be transmitted or written into a memory device, such as a virtual memory device according to the standardized device model 102, or a memory device 121 having a specification 123 from one vendor, or another memory device 122 having a different specification 124 from a different vendor/manufacturer.

The command 131 can include an opcode 132 and a command type 133 to specify the operation to be performed for the command, and one or more fields 134, 135, . . . , to specify parameters to be used with the command 131. The total size of the command 131 can be dependent on a combination of the opcode 132 and the command type 133.

For at least certain types of commands, a field of the command 131 is to provide a signature created for the command 131 for access control based on cryptography. The signature can be a Hash-based Message Authentication Code (HMAC) that can be validated using a cryptographic key stored in the secure memory device.

Optionally, the command 131 can include a field identifying a particular cryptographic key among a list of keys in the secure memory device for the validation of the signature. Optionally, each of the keys can have a corresponding monotonic counter; and a reference to a key can be made in the command 131 via a reference to the corresponding monotonic counter pre-associated with the key.

The signature provided in a field of the command 131 is to be validated against a message that includes the content of one or more of the fields (e.g., 134, 135) of the command 131, the opcode 132, and/or the command type 133.

In FIG. 2, a typical response 141 has a number of bytes to be returned by the corresponding memory device in response to the command 131. The total size of the response 141 can be dependent on a combination of the opcode 132 and the command type 133 specified in the corresponding command 131. For some types of commands, a field (e.g., 142 or 143) in the response 141 can include a signature created by the secure memory device (e.g., 121 or 122) in response to the command 131 to demonstrate the identity of the memory device, and/or the integrity of the content provided in the response 141.

For example, a command 131 can include an opcode 132 and a command type 133 configured to request a secure memory device to write a root key into the secure memory device. The secure memory device can be a device according to the standardized device model 102, or a device 121 according to the specification 123, or a device 122 according to the specification 124. Such a command 131 can include a field 134 to specify the root key to be stored into the secure memory device, and another field 135 to specify a signature (or a truncated portion of the signature) for the command 131. The signature (or a portion of it) is to be verified by the secure memory device before the command 131 is executed in the secure memory device to store the root key.

For example, a command 131 can include an opcode 132 and a command type 133 configured to request a secure memory device to update, based on its root key and data provided in a field 134 of the command 131, a cryptographic key used by the secure memory device to validate a signature. Such a command 131 can include a field 135 to specify a signature for the command 131; and the signature is generated for a message that includes the data provided in the field 134.

For example, a command 131 can include an opcode 132 and a command type 133 configured to request a secure memory device to increment a monotonic counter maintained within the secure memory device. Such a command 131 can include a field 134 to specify the current value of the monotonic counter, and a field 135 to specify a signature for the command 131; and the signature is generated for a message that includes the current value of the monotonic counter provided in the field 134.

For example, a command 131 can include an opcode 132 and a command type 133 configured to request a secure memory device to provide the value maintained in a monotonic counter within the secure memory device. Such a command 131 can include a field 134 to specify a tag and a field 135 to specify a signature for the command 131; and the signature is generated for a message that includes the tag.

For example, a command 131 can include an opcode 132 and a command type 133 configured to request a secure memory device to provide extended status data generated from execution of a prior command. Such a command 131 can include a field 135 to specify a signature for the command 131.

For example, a command 131 can include an opcode 132 and a command type 133 configured to request a secure memory device to provide a unique ID (UID) of the secure memory device. Such a command 131 can include a field 134 to specify a nonce (e.g., random number), but does not required a signature for the command 131. In response, the secure memory device is to provide its UID with an HMAC signature for a message that includes the nonce and the UID.

For example, a command 131 can include an opcode 132 and a command type 133 configured to provision/activate security features providing Core Root of Trust for Measurement (CRTM). Such a command 131 can include a field 134 to specify a nonce, and a field 135 to specify a signature for the command 131. The command 131 can further include a field to specify the current value of a predetermined monotonic counter in the secure memory device. The signature is generated for a message that includes the nonce using a server root key. In response, if the secure memory device is not already provisioned, the secure memory device can use the nonce to generate a root key, and activate access control based on cryptography and deactivate other locking/access control.

For example, a command 131 can include an opcode 132 and a command type 133 configured to deprovision/deactivate security features providing Core Root of Trust for Measurement (CRTM). Such a command 131 can include a field 134 to specify the current value of a predetermined monotonic counter in the secure memory device, and a field 135 to specify a signature for the command 131. The signature is generated for the command content (other than the signature itself) using a server root key. In response, if the secure memory device is not already deprovisioned, the secure memory device can deactivate access control based on cryptography and allow activation of other locking/access control.

For example, a command 131 can include an opcode 132 and a command type 133 configured to allow modifications to block locking registers in the secure memory device. Such a command 131 can include a field 134 to specify the current value of a predetermined monotonic counter in the secure memory device, and a field 135 to specify a signature for the command 131. The signature is generated for the command content (not including the signature itself) using a server session key.

For example, a command 131 can include an opcode 132 and a command type 133 configured to request the secure memory device to calculate a digest of a portion of content stored in the secure memory device and extend it to a register, or write it into another register. The portion can be identified using the values stored in predefined registers that specify the location and size of the portion in the secure memory device. Such a command 131 can include a field 134 to specify the current value of a predetermined monotonic counter in the secure memory device, and a field 135 to specify a signature for the command 131. The signature is generated for the command content (excluding the signature itself) using a server session key.

For example, a command 131 can include an opcode 132 and a command type 133 configured to indicate the start of register updates or to indicate the start of an update of a recovery block or recovery mode. Such a command 131 can include a field 134 to specify the current value of a predetermined monotonic counter in the secure memory device, and a field 135 to specify a signature for the command 131. The signature is generated for the command content (excluding the signature) using a server session key.

For example, a command 131 can include an opcode 132 and a command type 133 configured to write data into registers. Such a command 131 can include a field 134 to specify the current value of a predetermined monotonic counter in the secure memory device, and a field 135 to specify a signature for the command 131. The command 131 can include further fields to specify identification of a register to be written into, and data to be written into the register; and the signature is generated for the command content (excluding the signature) using a server session key.

For example, a command 131 can include an opcode 132 and a command type 133 configured to read data from registers. Such a command 131 can include a field 134 to specify the current value of a predetermined monotonic counter in the secure memory device, and a field 135 to specify the identification of a register to read, but does not required a signature for the command 131.

For example, a command 131 can include an opcode 132 and a command type 133 configured to indicate the end of register updates or to indicate the finish of recovery block updates or recovery mode. Such a command 131 can include a field 134 to specify the current value of a predetermined monotonic counter in the secure memory device, and a field 135 to specify a signature for the command 131. The signature is generated for the command content (excluding the signature) using a server session key.

For example, a command 131 can include an opcode 132 and a command type 133 configured to request the secure memory device to change a root key, a session key, or a unique device secret (UDS). Such a command 131 can include a field 134 to specify the current value of a predetermined monotonic counter in the secure memory device, a nonce, and a field 135 to specify a signature for the command 131. The signature is generated for the command content (excluding the signature) using a server session key.

For example, a command 131 can include an opcode 132 and a command type 133 configured to request the secure memory device to calculate a digest or HMAC in accordance with inputs provided in the command 131. Such a command 131 can include a field 134 to specify the current value of a predetermined monotonic counter in the secure memory device, an identification of a portion of memory in the memory device based on which the requested digest or HMAC is calculated, and a field 135 to specify an optional signature for the command 131. The signature is generated for the command content (excluding the signature) using a session key.

For example, a command 131 can include an opcode 132 and a command type 133 configured to request the secure memory device to perform operations related to program/write, erase, and/or append based on atomic signature verification. Such a command 131 can include a field 134 to specify the current value of a predetermined monotonic counter in the secure memory device, and a field 135 to specify an optional signature for the command 131. The command 131 can further include fields to specify an operation to be performed, an option for the operation, an identification of a source region of memory in the memory device that stores data for the operation, and an identification of a destination region of memory in the memory device for the operation; and the signature is generated for the command content (excluding the signature) using a session key.

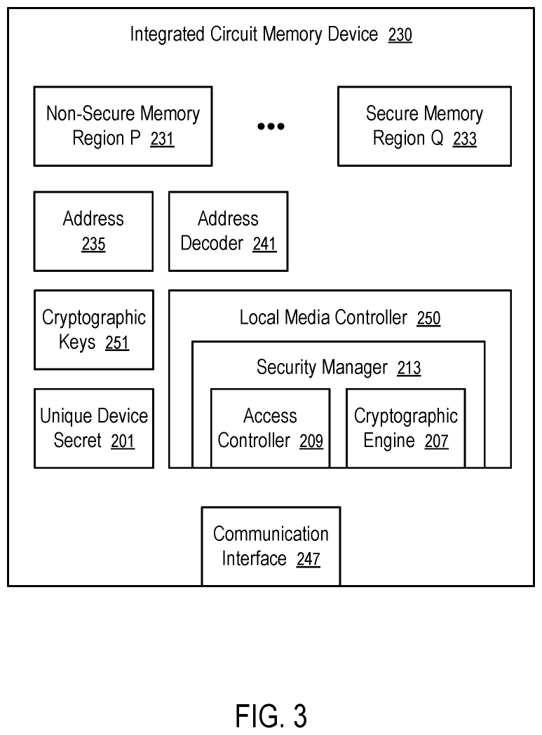

FIG. 3 illustrates an integrated circuit memory device having a security manager according to one embodiment. For example, the memory device 121 or 122 in FIG. 1 can be implemented using the memory device 230 of FIG. 3.

The integrated circuit memory device 230 can be enclosed in a single integrated circuit package. The integrated circuit memory device 230 includes multiple memory regions 231, . . . , 233 that can be formed in one or more integrated circuit dies.

A memory region (e.g., 231 or 233) can be allocated for use by a host system as a partition, a logical unit, or a namespace. Memory locations in the memory region (e.g., 231 or 233) can be specified by the host system via an address of Logical Block Addressing (LBA); and the memory device 230 can include an address map that specifies the relation between LBA addresses in a partition, logical unit, or namespace and physical addresses of corresponding memory cells used to provide the storage space allocated to the partition, logical unit, or namespace. In some implementations, the memory device 230 is configured in a memory sub-system (e.g., 210 illustrated in FIG. 6); and a memory sub-system controller 215 can be configured to perform the address mapping for the memory device 230.

A typical memory cell in a memory region (e.g., 231, . . . , 233) can be programmed to store one or more bits of data.

The memory device 230 has a local media controller 250, which can implement at least a portion of a security manager 213.

The security manager 213 of the memory device 230 can include an access controller 209, a cryptographic engine 207, an abstraction layer 108, and/or one or more device drivers (e.g., 111, 112).

The cryptographic engine 207 can be implemented via a logic circuit and/or instructions or microcode to perform cryptographic calculations, such as applying a cryptographic hash function to a data item to generate a hash value, encrypting a date item to generate cipher text using a cryptographic key, decrypting cipher text to recover a data item using a corresponding cryptographic key, generating a cryptographic key of symmetric cryptography and/or a pair of cryptographic keys of asymmetric cryptography, etc.

The access controller 209 controls access to at least one of the memory regions 231, . . . , 233 and/or other functions of the memory device 230 based on cryptographic keys that are representative of access privileges.

For example, the security manager 213 can control access to a secure memory region 233 based on a cryptographic key that is generated based on a secret 201 of the integrated circuit memory device 230 and/or a cryptographic key representative of an owner or an authorized user of the memory device 230. For example, when a request or command to write data into the secure memory region 233 is received in the integrated circuit memory device 230, the security manager 213 verifies whether the request is from a requester having the cryptographic key. If not, the security manager 213 may reject the write request. To demonstrate that the request is from an authorized requester, the requester can digitally sign the request, or a challenge message, using the cryptographic key. When the security memory device 230 determines that the digital signature is made using the correct cryptographic key, the requester is seen to have the permission to write the data into the secure memory region 233. For example, the memory device 230 can store one or more cryptographic keys 251 that are used to authenticate the digital signature of the signed request/command.

The memory device 230 can be configured to use different cryptographic keys 251 to access control different commands. For example, one cryptographic key 251 can be representative of the privilege to have a secure command executed in the memory device 230; and the secure command is used to specify that another cryptographic key 251 is representative of the privilege to read and/or write in a secure memory region 233. For example, the memory device 230 can have multiple secure memory regions (e.g., 233); and access to each of the secure memory regions (e.g., 233) can be controlled via a separate cryptographic key 251.

For example, the memory device 230 can have a unique device secret 201 that represents an identity of the memory device 230; and a cryptographic key 251 derived from the unique device secret 201 can be representative of an owner privilege to operate the memory device 230 and thus have secure commands executed in the memory device.

In general, the secure memory region 233 can have different security requirements for different types of accesses (e.g., read, write, erase). For example, the secure memory region 233 can be configured to require digital signatures verifiable via the cryptographic key 251 to write or change data in the secure memory region 233 but does not require a signed command to read the data from the secure memory region 233. Alternatively, the secure memory region 233 can be configured to require digital signatures verifiable via the cryptographic key 251 to read, write, and/or change data in the secure memory region 233. Alternatively, the secure memory region 233 can be configured to require digital signatures verifiable via different cryptographic keys for different operations, such as read, write, change, erase, etc., in the secure memory region 233.

The integrated circuit memory device 230 has a communication interface 247 to receive a command having an address 235. In response to the address 235 identifying a secure memory region (e.g., 233) that is configured with access control, the security manager 213 uses the cryptographic engine 207 to perform cryptographic operations for the verification that the request is from a requester having the cryptographic key authorized for the access to the memory region 233, before providing memory data retrieved from the memory region 233 using an address decoder 241. The address decoder 241 of the integrated circuit memory device 230 converts the address 235 into control signals to select a group of memory cells in the integrated circuit memory device 230; and the local media controller 250 of the integrated circuit memory device 230 performs operations to determine the memory data stored in the memory cells at the address 235.

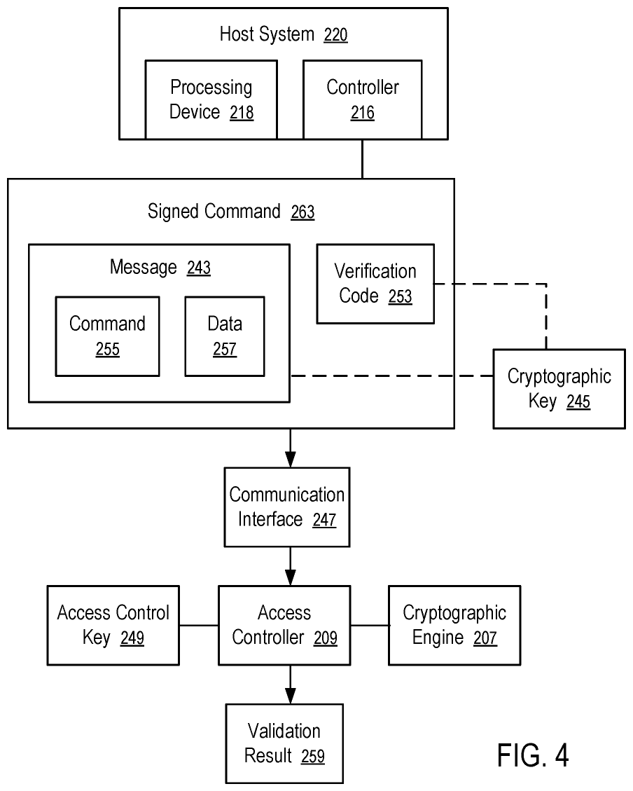

FIG. 4 illustrates a technique to control execution of a command in a memory device according to one embodiment. For example, the technique of FIG. 4 can be implemented in the memory device 230 of FIG. 3.

In FIG. 4, the access controller 209 is configured with an access control key 249 to determine whether a signed command 263 received in the communication interface 247 is from an entity having the privilege to have the command 255 executed in the secure memory device 230.

When a controller 216 of a host system 220 sends a command 255 to the communication interface 247 of the memory device 230, the access controller 209 determines whether the sender of the command 255 has the privilege to request the memory device 230 to execute the command 255. The host system 220 can include one or more processing devices 218 that execute instructions implementing an operating system and/or application programs.

A cryptographic key 245 is configured to represent the privilege that is to be checked using the access control key 249. A sender of the command 255 can generate a verification code 253 from the cryptographic key 245 and a message 243 containing the command 255.

The verification code 253 of the cryptographic key 245 and the message 243 can be constructed and/or validated using various techniques, such as hash digest, a digital signature, or a hash-based message authentication code, symmetric cryptography, and/or asymmetric cryptography. Thus, the verification code 253 is not limited to a particular implementation.

In general, verifying whether a sender of a message (e.g., 243) has a cryptographic key (e.g., 245) involves the validation of a verification code (e.g., 253) of the message (e.g., 243). The verification code can be in the form of a hash digest, a digital signature, a Hash-based Message Authentication Code (HMAC), a Cipher-based Message Authentication Code (CMAC), etc. The verification code is generated using the cryptographic key and the message as an input to cryptographic operations such as hashing, encrypting, and/or other computations such that it is generally impractical to generate the verification code without the cryptographic key and to generate the verification code from modified version of the message. Thus, when the recipient confirms that the received verification code is valid for the received message and a cryptographic key, the recipient can conclude that the sender has the corresponding cryptographic key and the received message is the same as the message used to generate the received cryptographic key.

In some implementations, the recipient performs the validation of a verification code of a message using the same cryptographic key as used by the sender to generate the verification code. For example, the recipient uses the same cryptographic key to generate the verification code of the received message and compare the generated verification code with the received verification code. If there is a match, the received verification code is valid for the received message; and the sender can be considered to have the cryptographic key. Otherwise, the received verification code is invalid for the received message; either the received message has been changed since the generation of the verification code, or the received verification code was generated using a different cryptographic key, or both.

In some implementations, the recipient performs the validation of a verification code of a message using a public cryptographic key in a key pair; and the sender generates the verification code using a private cryptographic key in the key pair. For example, the verification code can be generated by applying a hash function to the message to generate a hash value of the message. The cipher text of the hash value obtained through encrypting the hash value performed using an encryption key can be used as the verification code. A recipient of the message and the verification code performs validation using a corresponding decryption key, which is the same as the encryption key when symmetric cryptography is used and is a different key in a key pair when asymmetric cryptography is used. After recovering a hash value from the cipher text using the decryption key, the recovered hash value can be compared to the hash value of the received message; if there is a match, the received verification code is valid for the received message; otherwise, the received verification code is invalid for the received message. Alternatively, the recipient can use the encryption key to perform the validation without performing decryption. The recipient can generate the verification code of the message using the encryption key for comparison with the received verification code.

In some implementations, a message and a cryptographic key is combined to generate a hash value as the verification code, as in a technique of Hash-based Message Authentication Code (HMAC). For example, a cryptographic key can be used to generate two keys. After combining one of the two keys with the message to generate a message modified by the key, a cryptographic hash function can be applied to the key-modified message to generate a hash value, which is further combined with the other key to generate a further message. After applying the cryptographic hash function (or another cryptographic hash function) to the further message, a hash-based message authentication code is generated. A recipient of the message can use the same cryptographic key to generate the hash-based message authentication code of the received message for comparison with the received hash-based message authentication code. If there is a match, the validation is successful; otherwise, the validation fails.

In general, any techniques for generating and validating a verification code for a message from a sender and a cryptographic key used by the sender to generate the verification code can be used to determine whether the sender has the cryptographic key. The recipient is to use an appropriate cryptographic key to perform the validation, which can be the same as the cryptographic key used to generate the verification code, or in the same pair of asymmetric cryptographic key. Thus, the present disclosure is not limited to a particular technique of hash digest, digital signature, and/or hash-bashed message authentication code.

For convenience, a verification code (e.g., 253) generated for a message (e.g., 243) using a cryptographic key (e.g., 245) to represent both the message (e.g., 243) and the cryptographic key (e.g., 245) can be referred to, generally, as a digital signature of the message (e.g., 243) signed using the cryptographic key (e.g., 245), with the understanding that the verification code can be generated using various techniques, such as hash-based message authentication code.

In FIG. 4, the access controller 209 uses a corresponding access control key 249 to validate the verification code 253 submitted to the communication interface 247 for the command 255. The access controller 209 uses the cryptographic engine 207 to generate a validation result 259 of the received message 243 and the received verification code 253. Based on the validation result 259, the access controller 209 can selectively allow the command 255 to be executed within the memory device 230 or block the execution of the command 255.

For example, the access control key 249 can be one of the cryptographic keys 251 stored in the memory device 230. Different access control keys can be used to control different privileges for executing different commands and/or for executing a command operating on different sections or regions of memory cells.

For example, one cryptographic key 245 can be representative of the privilege to have a secure command executed in the memory device 230. When the secure command is executed, an access control key 249 is installed (or uninstalled) in the memory device 230 for the validation of a verification code of another cryptographic key representative of the privilege to have a read command (or a write command) executed to access the secure memory region 233.

Optionally, the cryptographic key 245 is generated in the process of validating the identity of the memory device 230 based on the unique device secret 201 of the memory device 230; and a secret known between the memory device 230 and an owner of the memory device 230 allows the generation of a session key as the cryptographic key 245 to represent the privileges to have selected commands executed in the memory device 230 during a communication session. The communication session can have a time limit and/or be terminated via a command to the memory device 230.

In some implementations, a same session key used as the cryptographic key 245 representative of a privilege and as the access control key 249 for the validation of verification codes (e.g., 253) generated using the cryptographic key 245.

In another implementations, a pair of cryptographic keys of asymmetric cryptography can be used for the session. The public key in the pair is used as the access control key 249; and the private key in the pair can be used as the cryptographic key 245 representative of the corresponding privilege.

After the installation in the memory device 230 the access control key 249 for the validation of the verification codes (e.g., 253) generated using the cryptographic key 245 representative of the privilege to read or write in the secure memory region 233, the cryptographic key 245 can be used by an authorized entity to generate the signed command 263. The signed command 263 can be transmitted to the communication interface 247 of the memory device 230 by the host system 220. After the access controller 209 validates the verification code 253 in the signed command 263, the access controller 209 allows the memory device 230 to execute the command 255.

The message 243 can include data 257 that represents restrictions on the request to execute the command 255.

For example, the data 257 can include an execution count value maintained within the memory device 230 such that previously used verification codes generated with lower counts cannot be replayed and are invalidated.

For example, the data 257 can include a cryptographic nonce established for a specific instance of a request to execute the command 255 such that the verification code 253 cannot be reused for another instance.

For example, the data 257 can include a time window in which the verification code 253 is valid.

For example, the data 257 can include the identification of a memory region in which the command 255 is allowed to be executed.

For example, the data 257 can include a type of operations that is allowed for the execution of the command 255 in the memory device 230.

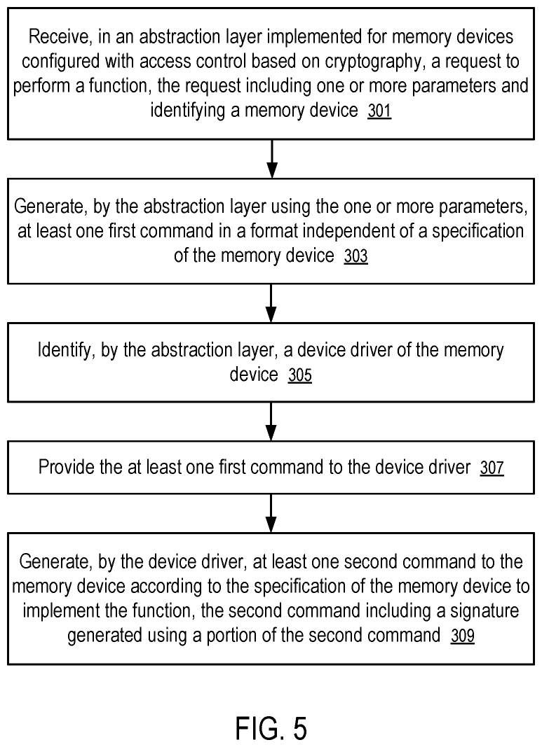

FIG. 5 shows a method of accessing a secure memory device according to one embodiment. The method of FIG. 5 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 5 is performed at least in part by the processing device 218 or controller 216 of the host system 220 in FIG. 4, the controller 215 and/or the controller 250 of a memory sub-system 210 of FIG. 6, or processing logic in the memory device 230 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 301, an abstraction layer 108, implemented for memory devices configured with access control based on cryptography, receives a request to perform a function, the request including one or more parameters and identifying a memory device (e.g., 121 or 122).

For example, the abstraction layer 108 can be implemented in part in an operating system kernel 101 and/or in at least one utility program 103.

For example, the utility program 103 can be configured to be executable as a command-line command.

At block 303, the abstraction layer 108 generates, using the one or more parameters, at least one first command (e.g., 105) in a format independent of a specification (e.g., 123) of the memory device (e.g., 121).

At block 305, the abstraction layer 108 identifies a device driver (e.g., 111) of the memory device (e.g., 121).

At block 307, the abstraction layer 108 provides (e.g., transmits or sends) the at least one first command (e.g., 105) to the device driver (e.g., 121) (e.g., by calling, invoking, executing the device driver 121).

At block 309, the device driver (e.g., 121) generates at least one second command (e.g., 125) to the memory device (e.g., 121) according to the specification (e.g., 123) of the memory device (e.g., 121) to implement the function. The second command (e.g., 125) includes a signature generated using a portion of the second command (e.g., 125).

For example, the signature can be a verification code 253, such as a Hash-based Message Authentication Code (HMAC) generated, using a cryptographic key 245, for a message 243 having the portion of the second command (e.g., 125).

For example, the one or more parameters provided to the utility program can include the signature generated using the cryptographic key 245.

In some implementations, the abstraction layer 108 has no access to the cryptographic key 245; and a separate application or program having the cryptographic key 245 is to provide the verification code 253 for the message 243 to be signed.

For example, based on the requested function, the abstraction layer 108 is configured to provide an opcode and a command type for the generation of the second command (e.g., 125) according to the specification from the at least one first command (e.g., 105).

For example, the opcode and the command type are configured in the second command to: write a cryptographic key into the memory device; update a cryptographic key in the memory device; increment a monotonic counter in the memory device; or retrieve data from the memory device; or any combination thereof.

For example, the opcode and the command type are configured in the second command to: activate security features of the memory device; deactivate security features of the memory device; start a session of updating registers in the memory device; end a session of updating registers in the memory device; calculate a digest of a portion of content stored in the memory device; change a portion of data stored in the memory device; or replace a cryptographic key in the memory device; or any combination thereof.

FIG. 6 illustrates an example computing system 200 that includes a memory sub-system 210 in accordance with some embodiments of the present disclosure. The memory sub-system 210 can include media, such as one or more volatile memory devices (e.g., memory device 240), one or more non-volatile memory devices (e.g., memory device 230), or a combination of such.

A memory sub-system 210 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 200 can be a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or such a computing device that includes memory and a processing device.

The computing system 200 can include a host system 220 that is coupled to one or more memory sub-systems 210. FIG. 6 illustrates one example of a host system 220 coupled to one memory sub-system 210. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 220 can include a processor chipset (e.g., processing device 218) and a software stack executed by the processor chipset. The processor chipset can include one or more cores, one or more caches, a memory controller (e.g., controller 216) (e.g., NVDIMM controller), and a storage protocol controller (e.g., PCIe controller, SATA controller). The host system 220 uses the memory sub-system 210, for example, to write data to the memory sub-system 210 and read data from the memory sub-system 210.

The host system 220 can be coupled to the memory sub-system 210 via a physical host interface. Examples of a physical host interface include, but are not limited to, a serial advanced technology attachment (SATA) interface, a peripheral component interconnect express (PCIe) interface, a universal serial bus (USB) interface, a Fibre Channel, a Serial Attached SCSI (SAS) interface, a double data rate (DDR) memory bus interface, a Small Computer System Interface (SCSI), a dual in-line memory module (DIMM) interface (e.g., DIMM socket interface that supports Double Data Rate (DDR)), an Open NAND Flash Interface (ONFI), a Double Data Rate (DDR) interface, a Low Power Double Data Rate (LPDDR) interface, or any other interface. The physical host interface can be used to transmit data between the host system 220 and the memory sub-system 210. The host system 220 can further utilize an NVM Express (NVMe) interface to access components (e.g., memory devices 230) when the memory sub-system 210 is coupled with the host system 220 by the PCIe interface. The physical host interface can provide an interface for passing control, address, data, and other signals between the memory sub-system 210 and the host system 220. FIG. 6 illustrates a memory sub-system 210 as an example. In general, the host system 220 can access multiple memory sub-systems via a same communication connection, multiple separate communication connections, and/or a combination of communication connections.

The processing device 218 of the host system 220 can be, for example, a microprocessor, a central processing unit (CPU), a processing core of a processor, an execution unit, etc. In some instances, the controller 216 can be referred to as a memory controller, a memory management unit, and/or an initiator. In one example, the controller 216 controls the communications over a bus coupled between the host system 220 and the memory sub-system 210. In general, the controller 216 can send commands or requests to the memory sub-system 210 for desired access to memory devices 230, 240. The controller 216 can further include interface circuitry to communicate with the memory sub-system 210. The interface circuitry can convert responses received from memory sub-system 210 into information for the host system 220.

The controller 216 of the host system 220 can communicate with controller 215 of the memory sub-system 210 to perform operations such as reading data, writing data, or erasing data at the memory devices 230, 240 and other such operations. In some instances, the controller 216 is integrated within the same package of the processing device 218. In other instances, the controller 216 is separate from the package of the processing device 218. The controller 216 and/or the processing device 218 can include hardware such as one or more integrated circuits (ICs) and/or discrete components, a buffer memory, a cache memory, or a combination thereof. The controller 216 and/or the processing device 218 can be a microcontroller, special purpose logic circuitry (e.g., a field programmable gate array (FPGA), an application specific integrated circuit (ASIC), etc.), or another suitable processor.

The memory devices 230, 240 can include any combination of the different types of non-volatile memory components and/or volatile memory components. The volatile memory devices (e.g., memory device 240) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 230 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 230 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 230 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 230 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 215 (or controller 215 for simplicity) can communicate with the memory devices 230 to perform operations such as reading data, writing data, or erasing data at the memory devices 230 and other such operations (e.g., in response to commands scheduled on a command bus by controller 216). The controller 215 can include hardware such as one or more integrated circuits (ICs) and/or discrete components, a buffer memory, or a combination thereof. The hardware can include digital circuitry with dedicated (e.g., hard-coded) logic to perform the operations described herein. The controller 215 can be a microcontroller, special purpose logic circuitry (e.g., a field programmable gate array (FPGA), an application specific integrated circuit (ASIC), etc.), or another suitable processor.

The controller 215 can include a processing device 217 (e.g., processor) configured to execute instructions stored in a local memory 219. In the illustrated example, the local memory 219 of the controller 215 includes an embedded memory configured to store instructions for performing various processes, operations, logic flows, and routines that control operation of the memory sub-system 210, including handling communications between the memory sub-system 210 and the host system 220.

In some embodiments, the local memory 219 can include memory registers storing memory pointers, fetched data, etc. The local memory 219 can also include read-only memory (ROM) for storing micro-code. While the example memory sub-system 210 in FIG. 6 has been illustrated as including the controller 215, in another embodiment of the present disclosure, a memory sub-system 210 does not include a controller 215, and can instead rely upon external control (e.g., provided by an external host, or by a processor or controller separate from the memory sub-system).

In general, the controller 215 can receive commands or operations from the host system 220 and can convert the commands or operations into instructions or appropriate commands to achieve the desired access to the memory devices 230. The controller 215 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 230. The controller 215 can further include host interface circuitry to communicate with the host system 220 via the physical host interface. The host interface circuitry can convert the commands received from the host system into command instructions to access the memory devices 230 as well as convert responses associated with the memory devices 230 into information for the host system 220.

The memory sub-system 210 can also include additional circuitry or components that are not illustrated. In some embodiments, the memory sub-system 210 can include a cache or buffer (e.g., DRAM) and address circuitry (e.g., a row decoder and a column decoder) that can receive an address from the controller 215 and decode the address to access the memory devices 230.

In some embodiments, the memory devices 230 include local media controllers 250 that operate in conjunction with memory sub-system controller 215 to execute operations on one or more memory cells of the memory devices 230. An external controller (e.g., memory sub-system controller 215) can externally manage the memory device 230 (e.g., perform media management operations on the memory device 230). In some embodiments, a memory device 230 is a managed memory device, which is a raw memory device combined with a local controller (e.g., local media controller 250) for media management within the same memory device package. An example of a managed memory device is a managed NAND (MNAND) device.

The controller 215 and/or a memory device 230 can include a security manager 213 discussed above. In some embodiments, the controller 215 and/or the local media controller 250 in the memory sub-system 210 can include at least a portion of the security manager 213. In other embodiments, or in combination, the controller 216 and/or the processing device 218 in the host system 220 can include at least a portion of the security manager 213. For example, the controller 215, the controller 216, and/or the processing device 218 can include logic circuitry implementing the security manager 213. For example, the controller 215, or the processing device 218 (e.g., processor) of the host system 220, can be configured to execute instructions stored in memory for performing the operations of the security manager 213 described herein. In some embodiments, the security manager 213 is implemented in an integrated circuit chip disposed in the memory sub-system 210. In other embodiments, the security manager 213 can be part of firmware of the memory sub-system 210, an operating system of the host system 220, a device driver, or an application, or any combination therein.

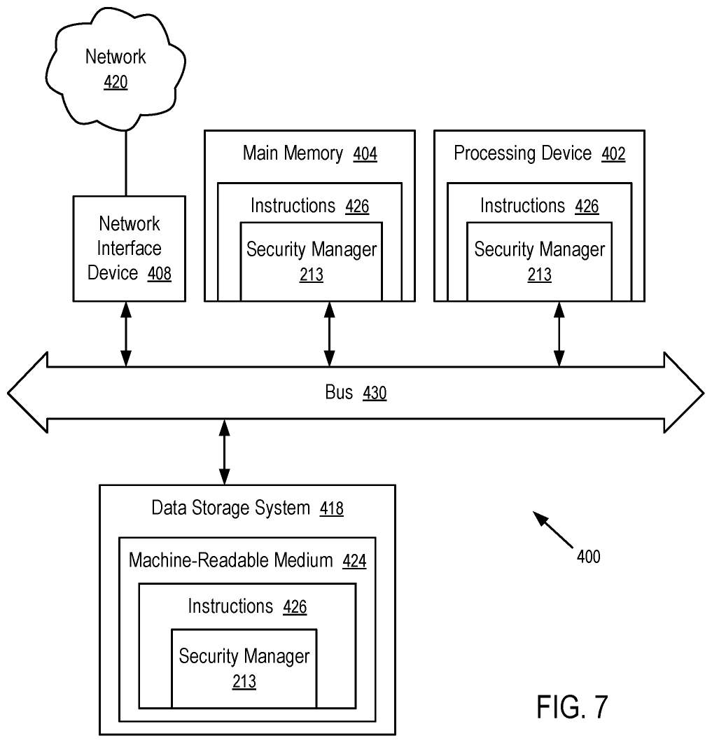

FIG. 7 illustrates an example machine of a computer system 400 within which a set of instructions, for causing the machine to perform any one or more of the methodologies discussed herein, can be executed. In some embodiments, the computer system 400 can correspond to a host system (e.g., the host system 220 of FIG. 6) that includes, is coupled to, or utilizes a memory sub-system (e.g., the memory sub-system 210 of FIG. 6) or can be used to perform the operations of a security manager 213 (e.g., to execute instructions to perform operations corresponding to the security manager 213 described with reference to FIGS. 1-5). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 210 of FIG. 6.

In one embodiment, the instructions 426 include instructions to implement functionality corresponding to a security manager 213 (e.g., the security manager 213 described with reference to FIGS. 1-5). While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, in an abstraction layer implemented for memory devices configured with access control based on cryptography, a request to perform a function, the request including one or more parameters and identifying a memory device;
generating, by the abstraction layer using the one or more parameters, at least one first command in a format independent of a command timing, format, or syntax configuration of the memory device;
identifying, by the abstraction layer, a device driver of the memory device; and
transmitting the at least one first command to the device driver to cause the device driver to generate at least one second command to the memory device according to the command timing, format, or syntax configuration of the memory device, the second command including a signature generated using a portion of the second command, wherein the function is implemented by execution of the at least one second command in the memory device.

2. The method of claim 1, wherein the abstraction layer includes an operating system kernel and at least one utility program.

3. The method of claim 2, wherein the utility program is executable as a command-line command.

4. The method of claim 2, wherein the signature is a Hash-based Message Authentication Code generated for a message having the portion of the second command using a cryptographic key.

5. The method of claim 4, wherein the one or more parameters include the signature.

6. The method of claim 5, wherein the abstraction layer has no access to the cryptographic key.

7. The method of claim 5, wherein the abstraction layer is configured to provide an opcode and a command type for generation of the second command according to the command timing, format, or syntax configuration from the at least one first command.

8. The method of claim 7, wherein the opcode and the command type are configured for the second command to:
write a cryptographic key into the memory device;
update a cryptographic key in the memory device;
increment a monotonic counter in the memory device; or
retrieve data from the memory device; or
any combination thereof.

9. The method of claim 7, wherein the opcode and the command type are configured for the second command to:
activate security features of the memory device;
deactivate security features of the memory device;
start a session of updating registers in the memory device;
end a session of updating registers in the memory device;
calculate a digest of a portion of content stored in the memory device;
change a portion of data stored in the memory device; or
replace a cryptographic key in the memory device; or
any combination thereof.

10. A non-volatile storage medium storing instructions which when executed on a computing device, cause the computing device to perform a method, comprising:
receiving, in an abstraction layer implemented for memory devices configured with access control based on cryptography, a request to perform a function, the request including one or more parameters and identifying a memory device;
generating, by the abstraction layer using the one or more parameters, at least one first command in a format independent of command and response timing, format, or syntax configurations of the memory device;
identifying, by the abstraction layer, a device driver of the memory device; and
sending the at least one first command to the device driver to cause the device driver to generate at least one second command to the memory device according to the command and response timing, format, or syntax configurations of the memory device, the second command including a signature generated using a portion of the second command, wherein the function is implemented by execution of the at least one second command in the memory device.

11. The non-volatile storage medium of claim 10, wherein the abstraction layer includes an operating system kernel and at least one utility program.

12. The non-volatile storage medium of claim 11, wherein the utility program is executable as a command-line command.

13. The non-volatile storage medium of claim 11, wherein the signature is a Hash-based Message Authentication Code generated for a message having the portion of the second command using a cryptographic key.

14. The non-volatile storage medium of claim 13, wherein the one or more parameters include the signature.

15. The non-volatile storage medium of claim 14, wherein the abstraction layer has no access to the cryptographic key.

16. The non-volatile storage medium of claim 14, wherein the abstraction layer is configured to provide an opcode and a command type for generation of the second command according to the command and response timing, format, or syntax configurations from the at least one first command.

17. The non-volatile storage medium of claim 16, wherein the opcode and the command type are configured for the second command to:
write a cryptographic key into the memory device;
update a cryptographic key in the memory device;
increment a monotonic counter in the memory device; or
retrieve data from the memory device; or
any combination thereof.

18. The non-volatile storage medium of claim 16, wherein the opcode and the command type are configured for the second command to:
activate security features of the memory device;
deactivate security features of the memory device;
start a session of updating registers in the memory device;
end a session of updating registers in the memory device;
calculate a digest of a portion of content stored in the memory device;
change a portion of data stored in the memory device; or
replace a cryptographic key in the memory device; or
any combination thereof.

19. An apparatus, comprising:
a memory device; and
at least one microprocess configured via instructions to:
receive, in an abstraction layer implemented for memory devices configured with access control based on cryptography, a request to perform a function, the request including one or more parameters and identifying the memory device;
generate, by the abstraction layer using the one or more parameters, at least one first command in a format independent of a manufacturer specification about command and response timing, format, or syntax configurations for the memory device;
identify, by the abstraction layer, a device driver of the memory device; and
send the at least one first command to the device driver to cause the device driver to generate at least one second command to the memory device according to the manufacturer specification for the memory device, the second command including a signature generated using a portion of the second command, wherein the function is implemented by execution of the at least one second command in the memory device.

20. The apparatus of claim 19, wherein the abstraction layer includes an operating system kernel and at least one utility program.
